(19) United States
(12) Patent Application Publication
(10) Pub. No.: US 2024/0345824 A1
(43) Pub. Date: Oct. 17, 2024

(54) INFORMATION PROCESSING DEVICE

(71) Applicant: TOYOTA JIDOSHA KABUSHIKI KAISHA, Toyota-shi (JP)

(72) Inventors: Tomoaki MIYAZAWA, Nagoya-shi (JP); Ryota NAKABAYASHI, Nagoya-shi (JP); Naoki YOMODA, Toyota-shi (JP); Atsushi MORI, Miyoshi-shi (JP); Hiroshi INOUE, Nagoya-shi (JP); Tsukasa KITAZAWA, Toyota-shi (JP)

(73) Assignee: TOYOTA JIDOSHA KABUSHIKI KAISHA, Toyota-shi (JP)

(21) Appl. No.: 18/429,663

(22) Filed: Feb. 1, 2024

(30) Foreign Application Priority Data
Apr. 12, 2023 (JP) 2023-064879

(51) Int. Cl. G06F 8/65

(52) U.S. Cl. CPC G06F 8/65

(57) ABSTRACT

A vehicle is equipped with an OTA master. A processing circuit of the OTA master predicts whether a prohibition period occurs when an activation process of activating software in a storage device of a target ECU is performed the next time the vehicle is started, the prohibition period being a period during which the vehicle is prohibited from starting to move or the use of a specific function in the vehicle is prohibited. When the processing circuit predicts that the prohibition period occurs when the activation process is performed the next time the vehicle is started, the processing circuit notifies a user of the vehicle of the length of the prohibition period.

### CROSS-REFERENCE TO RELATED APPLICATION

This application claims priority to Japanese Patent Application No. 2023-064879 filed on Apr. 12, 2023, incorporated herein by reference in its entirety.

### BACKGROUND

### 1. Technical Field

The present disclosure relates to information processing devices mounted on vehicles.

### 2. Description of Related Art

WO2021/177224 discloses a data update device that writes update data received via wireless communication from a center device installed outside a vehicle to a memory of an in-vehicle electronic control device. When the data update device receives from the center device a notification that update data is ready and information on a predicted value of the time required for the update, the data update device receives the update data from the center device on the condition that a user has accepted data update. The data update device writes the received update data to the memory of the electronic control device.

### SUMMARY

When update data is written to the memory of the electronic control device, the electronic control device performs an activation process of activating the update data the next time the vehicle is started. Depending on the type of update data, it may not be possible to cause the vehicle to travel or to use certain functions during the activation process. When it is not possible to start moving the vehicle immediately because the activation process is started while the vehicle is being started, the user may feel uncomfortable with not being able to start moving the vehicle immediately. When a period during which a specific function cannot be used is set because the activation process is started while the vehicle is being started, the user may feel uncomfortable with not being able to use the function.

An information processing device for solving the above problem is a device mounted on a vehicle. The information processing device includes a processing circuit. The processing circuit is configured to predict whether a prohibition period occurs when an activation process of activating software in a storage device included in the vehicle is performed next time the vehicle is started, the prohibition period being a period during which the vehicle is prohibited from starting to move or use of a specific function in the vehicle is prohibited, and when the processing circuit predicts that the prohibition period occurs when the activation process is performed the next time the vehicle is started, notify a user of the vehicle of a length of the prohibition period.

The information processing device is advantageous in that it can reduce the possibility of the user of the vehicle feeling uncomfortable when the vehicle is started for the first time after data is written to the storage device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a vehicle equipped with an information processing device according to a first embodiment, a mobile terminal carried by a user of the vehicle, and an OTA server installed outside the vehicle;

FIG. 2 is a flowchart showing a series of processes executed by the information processing device of the first embodiment;

FIG. 3 is a flowchart showing a series of processes executed by the information processing device of the first embodiment; and

FIG. 4 is a flowchart showing a part of a series of processes executed by an information processing device according to a second embodiment.

### DETAILED DESCRIPTION OF EMBODIMENTS

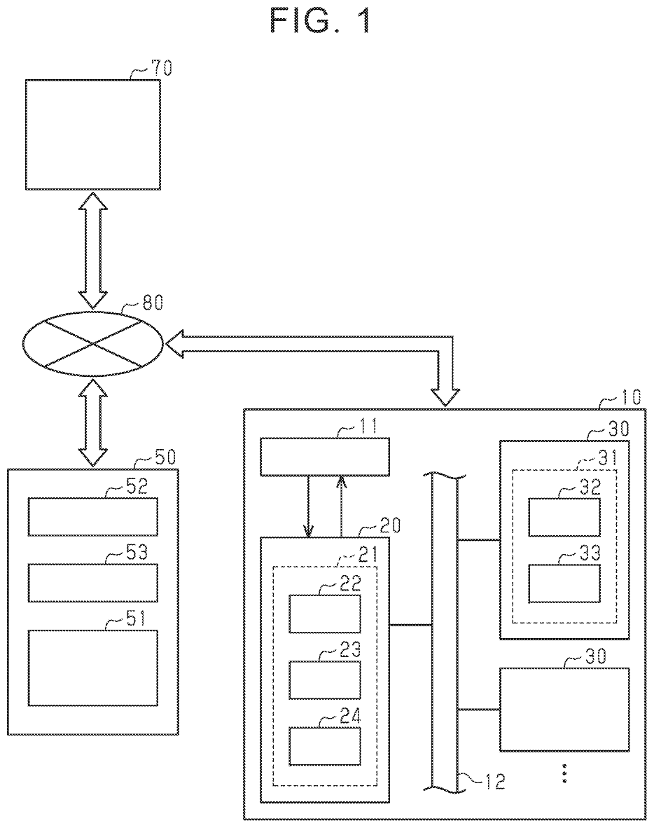

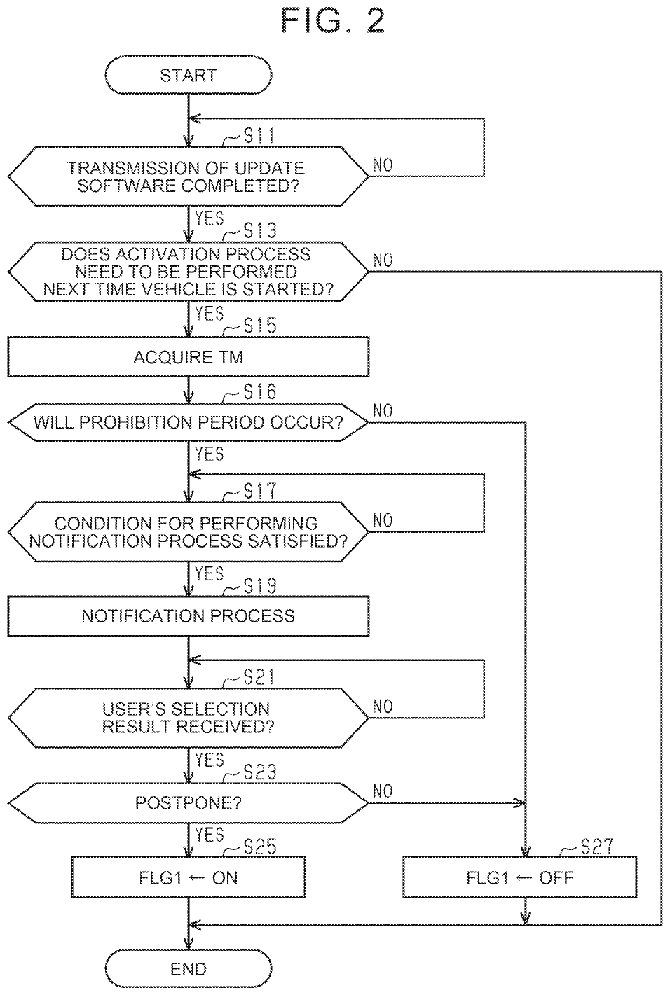

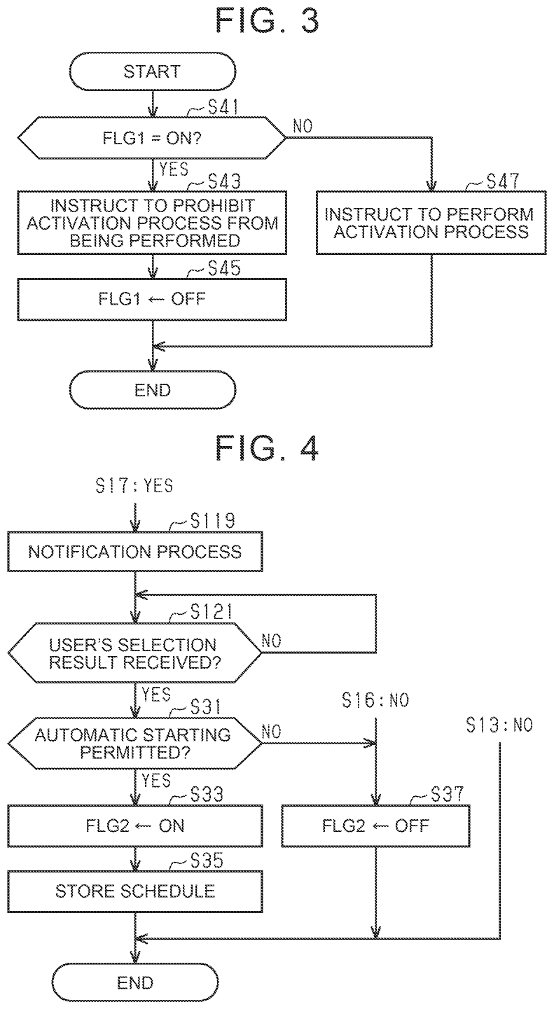

Hereinafter, one embodiment of an information processing device will be described according to FIGS. 1 to 3.

FIG. 1 illustrates an OTA server 70, a vehicle 10, and a mobile terminal 50 carried by a user of the vehicle 10.

### OTA Server

The OTA server 70 is a management server installed outside the vehicle 10. The OTA server 70 manages software for a plurality of vehicles registered in advance. The OTA server 70 transmits and receives various information to and from the vehicle 10 via the external network 80. The external network 80 is wireless communication. For example, the OTA server 70 transmits update software for the vehicle 10 to the vehicle 10 in response to a request from the vehicle 10.

### Vehicle

The vehicle 10 includes a communication device 11 and a plurality of electronic control devices. Hereinafter, the electronic control unit will be referred to as “ECU”. “ECU” is an abbreviation for “Electronic Control Unit.” The multiple ECUs include an OTA master 20 and multiple target ECUs 30. The OTA master 20 corresponds to the “information processing device”.

The communication device 11 is an interface of the vehicle 10 when transmitting and receiving information with a communication device outside the vehicle. For example, the communication device 11 receives update software and information specifying the ECU to be updated from the OTA server 70 via the external network 80. The update target ECU is a target ECU whose software is updated among the plurality of target ECUs 30. For example, the communication device 11 transmits various types of information to the mobile terminal 50 via the external network 80.

The communication device 11 transmits data received from a communication device outside the vehicle to the OTA master 20. The communication device 11 transmits the information received from the OTA master 20 to a communication device outside the vehicle.

The OTA master 20 manages software updates of the target ECU 30. The OTA master 20 can communicate with a plurality of target ECUs 30 via the in-vehicle network 12. An example of the in-vehicle network 12 is CAN. “CAN” is an abbreviation for “Controller Area Network.”

The OTA master 20 includes a processing circuit 21. For example, the processing circuit 21 includes a CPU 22, a first storage device 23, and a second storage device 24. In this case, the first storage device 23 is a nonvolatile memory, and the second storage device 24 is a volatile memory. The first storage device 23 stores software executed by the CPU 22. The second storage device 24 stores various information received from the communication device 11, such as information specifying update software and update mode ECU.

When the CPU 22 executes the software in the first storage device 23, the processing circuit 21 performs a series of processes of managing software update of the target ECU 30. The series of processes will be described later.

Each of the plurality of target ECUs 30 includes a processing circuit 31. For example, the processing circuit 31 includes a CPU 32 and a storage device 33. The storage device 33 is a nonvolatile memory. The storage device 33 stores various types of software executed by the CPU 32. When the processing circuit 31 of the target ECU 30 receives the update software from the OTA master 20 via the in-vehicle network 12, it writes the update software into the storage device 33. Thereafter, the processing circuit 31 completes the software update of the storage device 33 by executing an activation process.

In this embodiment, the processing circuit 31 executes activation processing when the vehicle 10 is started. Here, “when the vehicle 10 is started” is a case where the driver of the vehicle 10 turns on the driving switch of the vehicle 10. A state in which the driving switch is on is referred to as “driving the vehicle 10”, and a state in which the driving switch is off is referred to as “driving of the vehicle 10 is stopped”. Note that an example of the operation switch is an ignition switch.

### Mobile Device

The mobile terminal 50 includes a user interface 51, a communication device 52, and a processing circuit 53. The user interface 51 includes a display section that displays information to be notified to the user, and an operation section that is operated by the user.

Communication device 52 is an interface of mobile terminal 50 for communicating with vehicle 10 via network 80 outside the vehicle. The communication device 11 receives information transmitted by the vehicle 10 via the external network 80.

An example of the processing circuit 53 is an electronic control device. In this case, the processing circuit 53 includes a CPU and a storage device. The storage device stores a control program executed by the CPU. The processing circuit 53 executes various processes as the CPU executes the control program. For example, the processing circuit 53 causes the information received by the communication device 52 to be displayed on the display section of the user interface 51. For example, the processing circuit 53 causes the communication device 52 to transmit information corresponding to the result of the user's operation of the operation unit of the user interface 51 to the vehicle 10. A series of processes to decide whether to postpone execution of the activation process

A series of processes executed by the processing circuit 21 of the OTA master 20 when updating the software in the storage device 33 of the ECU to be updated will be described with reference to FIG. 2. When the processing circuit 21 starts transmitting the update software stored in the second storage device 24 to the ECU to be updated, it starts a series of processes shown in FIG. 2.

In S11, the processing circuit 21 determines whether transmission of the update software to the target ECU 30 has been completed. When the transmission is completed (S11: YES), the processing circuit 21 moves the process to S13. On the other hand, if the transmission is not completed (S11: NO), the processing circuit 21 repeats the determination in S11.

In S13, the processing circuit 21 determines whether it is necessary to execute activation processing at the next startup of the vehicle 10 in the target ECU 30 to which the update software has been transmitted. For example, the processing circuit 21 determines whether execution of the activation process is necessary based on the type of update software transmitted to the target ECU 30. When the processing circuit 21 determines that it is necessary to execute the activation process (S13: YES), the process proceeds to S15. On the other hand, when the processing circuit 21 determines that execution of the activation process is not necessary (S13: NO), it ends the series of processes.

In S15, the processing circuit 21 obtains a predicted processing time TM, which is a predicted value of the time required to execute the activation process. For example, the processing circuit 21 obtains the predicted processing time TM by analyzing the update software.

Depending on the type of update software, the vehicle 10 may be prohibited from starting to move or the use of a specific function out of a plurality of functions that can be used in the vehicle 10 may be prohibited while the activation process is being performed. When the vehicle 10 is started next time, when the vehicle 10 is prohibited from starting to move due to execution of the activation process, an occupant of the vehicle 10 may feel uncomfortable with a prohibition period occurring during which the vehicle 10 cannot start moving. Furthermore, when the use of the specific function is prohibited because the activation process is performed the next time the vehicle 10 is started, the occupant of the vehicle 10 may feel uncomfortable with the prohibition period occurring during which the specific function cannot be used. When such a prohibition period occurs the next time the vehicle 10 is started, the predicted processing time TM corresponds to the length of the prohibition period.

In the next S16, the processing circuit 21 predicts whether the above-mentioned prohibition period will occur the next time the vehicle 10 is started, assuming that the activation process will be executed the next time the vehicle 10 is started. That is, the process of S17 is a process of predicting whether a prohibition period will occur when the activation process is executed at the next startup of the vehicle 10. When the processing circuit 21 predicts that the prohibition period will occur at the next startup of the vehicle 10 (S16: YES), the process proceeds to S17. On the other hand, when the processing circuit 21 predicts that the prohibition period will not occur (S16: NO), the process proceeds to S27.

In S17, the processing circuit 21 determines whether the conditions for executing the notification process are satisfied. For example, when the series of processes shown in FIG. 2 is executed while the vehicle 10 is being driven, the processing circuit 21 determines the execution conditions when the driving switch of the vehicle 10 is turned off and the driving of the vehicle 10 is stopped. It is determined that the following holds true. Further, the processing circuit 21 may determine that the execution condition is satisfied when the user gets off the vehicle. Further, for example, if the series of processes shown in FIG. 2 is being executed while the drive of the vehicle 10 is stopped, the processing circuit 21 will execute the process when the writing of the update software to the storage device 33 of the target ECU 30 is completed. It is determined that the condition is met. Then, when the processing circuit 21 determines that the conditions for executing the notification process are satisfied (S17: YES), the process proceeds to S19. On the other hand, if the processing circuit 21 determines that the execution condition is not satisfied (S17: NO), the processing circuit 21 repeats the determination in S17 until the execution condition is satisfied.

In S19, the processing circuit 21 notifies the user of the vehicle 10 of the predicted processing time TM acquired in S15 as the length of the prohibition period by executing a notification process. For example, in the notification process, the processing circuit 21 causes the communication device 11 to transmit information regarding the predicted processing time TM to the mobile terminal 50. At this time, the processing circuit 21 also causes the mobile terminal 50 to transmit information that allows the user to select whether to postpone execution of the activation process.

When the communication device 52 of the mobile terminal 50 receives the information transmitted by the vehicle 10, the processing circuit 53 displays the predicted processing time TM indicated by the information on the display section of the user interface 51. Furthermore, the processing circuit 53 allows the user to select whether to postpone execution of the activation process. When the operation on the operation unit of the user interface 51 is an operation for postponing execution of the activation process, the processing circuit 53 sends a notification to the effect that the execution of the activation process is postponed from the communication device 52 as a result of the user's selection. The vehicle 10 is made to transmit. On the other hand, if the operation on the operation unit is an operation for not postponing the execution of the activation process, the processing circuit 53 sends a notification to the vehicle 10 from the communication device 52 as a result of the user's selection that the execution of the activation process will not be postponed. have it sent to

That is, the communication process of S19 is a process of notifying the user of the vehicle 10 of the length of the prohibition period. After executing the communication process, the processing circuit 21 moves the process to S21. In S21, the processing circuit 21 determines whether the user's selection result has been received from the mobile terminal 50. When the processing circuit 21 receives the selection result (S21: YES), the process proceeds to S23. On the other hand, if the processing circuit 21 has not received the selection result (S21: NO), the processing circuit 21 repeats the determination in S21 until the selection result is received.

In S23, the processing circuit 21 determines whether the user requests postponement of execution of the activation process based on the user's selection result. If the processing circuit 21 determines that the user has selected postponement (S23: YES), the process proceeds to S25. On the other hand, if the processing circuit 21 determines that the user has not selected postponement (S23: NO), the process proceeds to S27.

In S25, the processing circuit 21 sets the postponement flag FLG1 to ON. The postponement flag FLG1 is a flag that is set to ON when execution of the activation process is prohibited the next time the vehicle 10 is started. After that, the processing circuit 21 ends the series of processing.

A series of processes when starting the vehicle

In S27, the processing circuit 21 sets the postponement flag FLG1 to OFF. After that, the processing circuit 21 ends the series of processing.

Referring to FIG. 3, a series of processes executed by the processing circuit 21 of the OTA master 20 when the vehicle 10 is started is executed. The processing circuit 21 executes the series of processes when the vehicle 10 is started.

In S41, the processing circuit 21 determines whether the postponement flag FLG1 is set to on. When the postponement flag FLG1 is set to on (S41: YES), the processing circuit 21 shifts the process to S43. On the other hand, if the postponement flag FLG1 is set to OFF (S41: NO), the processing circuit 21 shifts the process to S47.

In S43, the processing circuit 21 instructs the target ECU 30 to prohibit execution of the activation process. In the next step S45, the processing circuit 21 sets the postponement flag FLG1 to OFF. After that, the processing circuit 21 ends the series of processing.

In S47, the processing circuit 21 instructs the target ECU 30 to execute the activation process. After that, the processing circuit 21 ends the series of processing. In the target ECU 30, when the prohibition of execution of the activation process is instructed, the processing circuit 31 does not execute the activation process when the vehicle 10 is started. In this case, the processing circuit 31 postpones updating the software of its own storage device 33. On the other hand, in the target ECU 30, when the execution of the activation process is instructed, the processing circuit 31 executes the activation process when the vehicle 10 is started. Thereby, the processing circuit 31 can update the software of its own storage device 33.

### Actions and Effects of this Embodiment

The operation and effect when the update software is written into the storage device 33 of the first target ECU 30 among the plurality of target ECUs 30 while the vehicle 10 is being driven will be described.

When the update software is transmitted from the OTA master 20 to the first target ECU 30, the processing circuit 31 of the first target ECU 30 writes the update software into its own storage device 33.

In the OTA master 20, the processing circuit 21 determines whether it is necessary to execute activation processing in the first target ECU 30 at the next startup of the vehicle 10. When the processing circuit 21 determines that it is necessary to execute the activation process, it acquires the predicted processing time TM. When the vehicle 10 is prohibited from starting to move or the use of a specific function in the vehicle 10 is prohibited while the activation process is being performed, the predicted processing time TM corresponds to the length of the prohibition period.

The processing circuit 21 predicts whether a prohibition period will occur in which the vehicle 10 is prohibited from starting to move or the use of a specific function in the vehicle 10 is prohibited when the activation process is performed the next time the vehicle 10 is started. When the processing circuit 21 predicts that a prohibition period will occur, it notifies the user of the predicted processing time TM as the length of the prohibition period by executing a notification process.

When the user is notified of the predicted processing time TM in this manner, the user can recognize that a prohibition period will occur the next time the vehicle 10 is started. Further, the user can know the temporal length of the prohibition period. As a result, the user is less likely to feel uncomfortable even if the vehicle 10 cannot start to move immediately upon starting of the vehicle 10, or there is a period during which a specific function cannot be used. Therefore, the OTA master 20 can prevent the user from feeling uncomfortable when starting the vehicle 10 for the first time after the update software is written in the storage device 33 of the first target ECU 30.

In this embodiment, the following effects can be further obtained. (1-1) If the processing circuit 21 of the OTA master 20 predicts that a prohibition period will occur when the activation process is executed the next time the vehicle 10 is started, the processing circuit 21 executes the activation process the next time the vehicle 10 is started. The user is asked to select whether to activate the activation process or to postpone execution of the activation process. If the user selects to execute the activation process, the processing circuit 21 instructs the first target ECU 30 to execute the activation process the next time the vehicle 10 is started.

On the other hand, if the user chooses to postpone execution of the activation process, the processing circuit 21 instructs the first target ECU 30 to prohibit execution of the activation process the next time the vehicle 10 is started. In this case, the activation process will not be executed in the first target ECU 30 when the vehicle 10 is started next time. That is, the prohibition period does not actually occur. As a result, when the vehicle 10 is started, the user can start moving the vehicle 10 immediately or use the specific function immediately.

Note that unless the activation process is executed when the vehicle 10 is started, the software update of the storage device 33 will not be completed. Therefore, it is preferable that the first target ECU 30 performs the activation process at the next startup of the vehicle 10. Furthermore, when execution of the activation process is postponed, the user may be allowed to select at what timing the activation process is to be executed.

(1-2) The predicted processing time TM is notified to the user via the mobile terminal 50 owned by the user. Thereby, the OTA master 20 can notify the user of the predicted processing time TM even after the user gets off the vehicle 10.

### Second Embodiment

A second embodiment of the information processing device will be described with reference to FIG. 4. The second embodiment differs from the first embodiment in the processing content when it is determined that the prohibition period will occur the next time the vehicle is started. Therefore, in the following description, parts that are different from the first embodiment will be mainly explained, and the same reference numerals will be given to the same member configurations as in the first embodiment, and redundant explanation will be omitted.

With reference to FIG. 4, a series of processes executed by the processing circuit 21 of the OTA master 20 when updating the software in the storage device 33 of the ECU to be updated will be described.

When the execution condition for the notification process is satisfied (S17: YES), the processing circuit 21 shifts the process to S119. In S119, the processing circuit 21 notifies the user of the vehicle 10 of the predicted processing time TM as the length of the prohibition period in the notification process. In the present embodiment, in the notification process, the processing circuit 21 proposes to the user that the vehicle 10 be automatically activated in order to execute the activation process, on the condition that the user has not requested activation of the vehicle 10. do. The processing circuit 21 causes the proposal to be transmitted to the user's mobile terminal 50 together with information regarding the predicted processing time TM.

When the notification process is executed, information regarding the predicted processing time TM and the above proposal are transmitted to the mobile terminal 50 via the external network 80. When the communication device 52 of the mobile terminal 50 receives the information and the proposal, the processing circuit 53 of the mobile terminal 50 displays a message indicating the predicted processing time TM and the proposal indicated by the information on the display section of the user interface 51.

The user decides whether to accept the proposal by operating the operation section of the user interface 51. The processing circuit 53 causes the communication device 52 to transmit the operation result of the operation unit to the vehicle 10. Note that if the user accepts the above proposal, the processing circuit 53 allows the user to decide at what timing the vehicle 10 should be automatically activated to execute the activation process. The processing circuit 53 also causes the communication device 52 to transmit such an automatic start schedule to the vehicle 10.

That is, the communication process of S119 is a process of notifying the user of the vehicle 10 of the length of the prohibition period. In the next step S121, the processing circuit 21 determines whether the user's selection result has been received from the mobile terminal 50. When the processing circuit 21 receives the selection result (S121: YES), the process proceeds to S31. On the other hand, if the processing circuit 21 has not received the selection result (S121: NO), the processing circuit 21 repeats the determination in S121 until the selection result is received.

In S31, the processing circuit 21 determines, based on the user's selection result, whether the user has given permission to automatically start the vehicle 10 to execute the activation process. If the processing circuit 21 determines that the user has given permission (S31: YES), the process proceeds to S33. On the other hand, if the processing circuit 21 determines that the user has not given permission (S31: NO), the process proceeds to S37.

In S33, the processing circuit 21 sets the automatic start permission flag FLG2 to ON. The automatic start permission flag FLG2 is a flag that is set to ON when automatic start of the vehicle 10 is permitted. In subsequent S35, the processing circuit 21 stores the timing for automatically starting the vehicle 10 determined by the user as a schedule regarding automatic starting. After that, the processing circuit 21 ends the series of processing.

In S37, the processing circuit 21 sets the automatic start permission flag FLG2 to OFF. In this embodiment, the processing circuit 21 executes the process of S37 even if it is determined in S16 that the prohibition period does not occur. After that, the processing circuit 21 ends the series of processing.

When the automatic start permission flag FLG2 is set to ON, the processing circuit 21 instructs the vehicle 10 to start automatically when the timing for automatically starting the vehicle 10 determined by the user comes. Specifically, the processing circuit 21 instructs automatic startup of the vehicle 10 on the condition that the user does not request startup of the vehicle 10, that is, on the condition that the driving switch is off. When the vehicle 10 is started, the processing circuit 21 instructs the target ECU 30 to execute activation processing.

The processing circuit 31 of the target ECU 30 executes the activation process when instructed by the OTA master 20 to execute the activation process. Thereby, the processing circuit 31 can complete updating the software of its own storage device 33.

When the activation process in the target ECU 30 is executed, the processing circuit 21 of the OTA master 20 sets the automatic start permission flag FLG2 to OFF. After that, the processing circuit 21 stops driving the vehicle 10.

### Effects of this Embodiment

In this embodiment, the following effects can be further obtained. (2-1) If the user does not request startup of the vehicle 10, that is, if the operation switch is off, the vehicle 10 is automatically started according to an instruction from the OTA master 20. At this time, activation processing is executed in the target ECU 30 according to instructions from the OTA master 20. That is, the software update of the storage device 33 of the target ECU 30 is completed during a period in which the user does not request startup of the vehicle 10. Therefore, the activation process does not need to be executed the next time the vehicle 10 is started according to the user's request. Therefore, when the vehicle 10 is started, the user can start moving the vehicle 10 immediately or use the specific function immediately.

### Modifications

The above embodiments can be modified and implemented as follows. The plurality of embodiments described above and the following modified examples can be implemented in combination with each other within a technically consistent range.

If the user is in the vehicle, the processing circuit 21 may notify the user of the predicted processing time TM via a user interface provided in the vehicle cabin.

If the update software is written in the storage device 33 of the target ECU 30, the processing circuit 21 may execute the notification process at a time other than when the vehicle 10 is stopped or when the user gets off the vehicle.

If the OTA master 20 can notify the user of the predicted processing time TM, the OTA master 20 may propose to postpone execution of the activation process or to automatically start the vehicle 10 and execute the activation process. You don't have to do anything like that.

The processing circuit 21 of the OTA master 20 is not limited to one that includes a CPU and a ROM and executes software processing. That is, the processing circuit 21 may have any of the following configurations (a), (b), and (c).

(a) The processing circuit 21 includes one or more processors that execute various processes according to computer programs. The processor includes a CPU and memory such as RAM and ROM. The memory stores a program code or an instruction configured to execute the CPU to perform processes. Memory, or computer-readable media, includes any available media that can be accessed by a general purpose or special purpose computer.

(b) The processing circuit 21 includes one or more dedicated hardware circuits that execute various processes. Dedicated hardware circuits may include, for example, application specific integrated circuits, i.e., ASICs or FPGAs. Note that ASIC is an abbreviation for “Application Specific Integrated Circuit,” and FPGA is an abbreviation for “Field Programmable Gate Array.”

(c) The processing circuit 21 includes a processor that executes some of the various processes according to a computer program, and a dedicated hardware circuit that executes the remaining processes of the various processes.

What is claimed is:

1. An information processing device that is mounted on a vehicle, the information processing device comprising a processing circuit, the processing circuit being configured to
predict whether a prohibition period occurs when an activation process of activating software in a storage device included in the vehicle is performed next time the vehicle is started, the prohibition period being a period during which the vehicle is prohibited from starting to move or use of a specific function in the vehicle is prohibited, and
when the processing circuit predicts that the prohibition period occurs when the activation process is performed the next time the vehicle is started, notify a user of the vehicle of a length of the prohibition period.

2. The information processing device according to claim 1, wherein the processing circuit is configured to, when the processing circuit predicts that the prohibition period occurs when the activation process is performed the next time the vehicle is started, allow the user to select whether to perform the activation process the next time the vehicle is started or postpone performing the activation process.

3. The information processing device according to claim 1, wherein the processing circuit is configured to
when the processing circuit predicts that the prohibition period occurs when the activation process is performed the next time the vehicle is started,
propose the user that the vehicle be automatically started in order to perform the activation process, on a condition that the user does not request to start the vehicle,
instruct to automatically start the vehicle when the user permits automatic starting of the vehicle, and
instruct to perform the activation process when the vehicle is automatically started.

4. The information processing device according to claim 1, wherein the processing circuit is configured to notify the user of the vehicle of the length of the prohibition period when driving of the vehicle is stopped or when the user gets out of the vehicle.

5. The information processing device according to claim 1, wherein the processing circuit is configured to notify the user of the length of the prohibition period by sending information on the length of the prohibition period to a mobile terminal carried by the user.
